(19) United States
(12) Patent Application Publication
(10) Pub. No.: US 2016/0083292 A1
(43) Pub. Date: Mar. 24, 2016

(54) METHOD FOR MANUFACTURING TEMPERED GLASS SHEET

(71) Applicant: Nippon Electric Glass Co., Ltd., Shiga (JP)

(72) Inventors: Masashi TABE, Shiga (JP); Hiroki KATAYAMA, Shiga (JP); Kozo KOBAYASHI, Shiga (JP); Takuji OKA, Shiga (JP); Naoki TOYOFUKU, Shiga (JP); Shigeru SERA, Shiga (JP)

(21) Appl. No.: 14/892,303

(22) PCT Filed: May 22, 2014
(86) PCT No.: PCT/JP2014/063614

§ 371 Date: Nov. 19, 2015

(30) Foreign Application Priority Data
May 24, 2013 (JP) 2013-109799

(51) Int. Cl. C03C 21/00; C03C 3/093; C03B 25/02; C03C 3/091

(52) U.S. Cl. CPC C03C 21/002; C03C 3/091; C03C 3/093; C03B 25/025

(57) ABSTRACT

A method of manufacturing a tempered glass sheet includes: an arrangement step of arranging a plurality of glass sheets to be tempered, each having a substantially rectangular shape and a sheet thickness of 1.0 mm or less, in a support in an upright posture in a thickness direction at an interval of 10 mm or less, to thereby obtain an arrangement of glass sheets to be tempered; a tempering step of immersing the arrangement of glass sheets to be tempered in an ion exchange solution so as to subject the arrangement of glass sheets to be tempered to ion exchange treatment, to thereby obtain an arrangement of tempered glass sheets; an annealing step of annealing the arrangement of tempered glass sheets; and a removal step of removing each of tempered glass sheets forming the arrangement of tempered glass sheets from the support.

### TECHNICAL FIELD

The present invention relates to a method of manufacturing a tempered glass sheet, and more particularly, to a method of manufacturing a tempered glass sheet suitable for a cover glass of a display device, such as a cellular phone, a digital camera, or a personal digital assistant (PDA).

### BACKGROUND ART

Display devices, such as a cellular phone, a digital camera, a PDA, a touch panel display, and a large-screen television, show a tendency of further prevalence.

Hitherto, in those applications, a resin sheet, such as an acrylic sheet, has been used as a protective member for protecting a display. However, owing to a low Young's modulus of the resin sheet, the resin sheet is liable to bend when a display surface of the display is pushed with a pen, a human finger, or the like. Therefore, the resin sheet causes a display failure through its contact with an internal display in some cases. The resin sheet also involves a problem of being liable to have flaws on its surfaces, resulting in easy reduction of visibility. A solution to those problems is to use a glass sheet as the protective member. The glass sheet for this application is required to, for example, (1) have a high mechanical strength, (2) have a low density and a light weight, (3) be able to be supplied at low cost in a large amount, (4) be excellent in bubble quality, (5) have a high light transmittance in a visible region, and (6) have a high Young's modulus so as not to bend easily when its surface is pushed with a pen, a finger, or the like. In particular, a glass sheet which does not satisfy the requirement (1) cannot serve as the protective member, and hence a tempered glass sheet obtained through ion exchange treatment has been used as the protective member heretofore (see Patent Literatures 1 and 2, and Non Patent Literature 1).

Hitherto, the tempered glass sheet has been produced by so-called “pre-tempering cutting”, which is a method comprising cutting a glass sheet to be tempered so as to have a predetermined shape in advance and then subjecting the resultant to ion exchange treatment. In recent years, so-called “post-tempering cutting”, which is a method comprising subjecting a large glass sheet to be tempered to ion exchange treatment and then cutting the resultant so as to have a predetermined size, has been under consideration. When the post-tempering cutting is performed, there is an advantage in that the manufacturing efficiency of the tempered glass sheet and various devices dramatically improves.

### CITATION LIST

### Patent Literature

Patent Literature 1: JP 2006-83045 A
Patent Literature 2: JP 2011-88763 A

### Non Patent Literature

Non Patent Literature 1: Tetsuro Izumitani et al., “New glass and physical properties thereof,” First edition, Management System Laboratory. Co., Ltd., Aug. 20, 1984, p. 451-498

### SUMMARY OF INVENTION

### Technical Problem

Meanwhile, a float method enables thin glass sheets to be mass-produced at low cost, and hence the float method is generally used as a method of forming a glass sheet to be tempered. For example, in Patent Literature 2, there is disclosed a glass sheet to be tempered, which is formed by the float method, comprising as a glass composition, in terms of mol %, 67% to 75% of SiO₂, 0% to 4% of Al₂O₃, 7% to 15% of Na₂O, 1% to 9% of K₂O, 6% to 14% of MgO, 0% to 1% of CaO, 0% to 1.5% of ZrO₂, 71% to 75% of SiO₂+Al₂O₃, and 12% to 20% of Na₂O+K₂O and having a thickness of 1.5 mm or less.

However, when the glass sheet to be tempered, which is formed by the float method, is subjected to ion exchange treatment, there arises a problem in that the properties and composition in the vicinity of a surface vary between a side brought into contact with a tin bath during a glass manufacturing step, what is called a bottom surface, and an opposite side thereof, what is called a top surface, and the tempered glass sheet is warped toward the top surface side in a convex shape. When the warpage level of the tempered glass sheet is large, the yield of the tempered glass sheet decreases.

On the other hand, when a glass sheet to be tempered is formed by a method other than the float method, for example, an overflow down-draw method, the differences in properties and composition between the front surface and the back surface can be reduced, and hence the warpage level caused by the differences can be reduced. However, even in the case where a glass sheet to be tempered is formed by a method other than the float method, when the glass sheet to be tempered is thinned, a tempered glass sheet may be warped.

This phenomenon is liable to become conspicuous in the case where a thin glass sheet to be tempered is subjected to ion exchange treatment to obtain a tempered glass sheet. This phenomenon is liable to become further conspicuous in the case where a plurality of glass sheets to be tempered are concurrently subjected to the ion exchange treatment to obtain tempered glass sheets. It should be noted that, in the case where a plurality of glass sheets to be tempered are concurrently subjected to the ion exchange treatment, when the warpage level of the tempered glass sheets is too large, there is also a risk in that the tempered glass sheets interfere with each other to cause flaws.

The present invention has been made in view of the above-mentioned circumstances, and a technical object of the present invention is to devise a method of manufacturing a tempered glass sheet, which is capable of reducing a warpage level to the extent possible even in the case of subjecting a plurality of thin glass sheets to be tempered to ion exchange treatment to obtain tempered glass sheets.

### Solution to Problem

The inventors of the present invention have made extensive studies, and as a result, have found that the technical object can be achieved by arranging a plurality of thin glass sheets to be tempered in a support at a predetermined interval and subjecting the glass sheets to be tempered to ion exchange treatment, followed by annealing. The finding is proposed as the present invention. That is, a method of manufacturing a tempered glass sheet of the present invention comprises: an arrangement step of arranging a plurality of glass sheets to be tempered, each having a substantially rectangular shape and a sheet thickness of 1.0 mm or less, in a support in an upright posture in a thickness direction at an interval of 10 mm or less, to thereby obtain an arrangement of glass sheets to be tempered; a tempering step of immersing the arrangement of glass sheets to be tempered in an ion exchange solution so as to subject the arrangement of glass sheets to be tempered to ion exchange treatment, to thereby obtain an arrangement of tempered glass sheets; an annealing step of annealing the arrangement of tempered glass sheets after removing the arrangement of tempered glass sheets from the ion exchange solution; and a removal step of removing each of tempered glass sheets forming the arrangement of tempered glass sheets from the support. Herein, the phrase “substantially rectangular shape” includes a square as well as a rectangle. The phrase further includes the case where the shape partially has a curved surface, a hole, or the like, for example, the case where a corner of a rectangle is chamfered into a curved surface shape or a notched shape and also includes the case where the shape has a hole or an opening in a surface. The phrase “at an interval of 10 mm or less” includes the case where the glass sheets to be tempered are partially arranged at an interval of more than 10 mm as long as there is a region in which the glass sheets to be tempered are arranged at an interval of 10 mm or less. It should be noted that all the tempered glass sheets are preferably arranged at an interval of 10 mm or less. The phrase “in an upright posture” is not limited to a perfect upright posture and includes a state in which the glass sheets to be tempered are inclined at about from 0° to 30° with respect to a vertical direction. The “annealing” refers to the case of cooling at a lower speed as compared to that of rapid cooling, such as removal from the ion exchange solution directly to room temperature, for example, the case where a period of time during which the temperature is decreased at a temperature decrease rate of 30° C./min or less in a temperature range of 150° C. or more and less than a strain point is 1 minute or more.

A related-art tempered glass sheet has been produced by performing rapid cooling to room temperature after removal from the ion exchange solution. The inventors of the present invention have made extensive studies, and as a result, have found that the warpage level can be reduced by annealing the tempered glass sheet after the ion exchange treatment. The reason that the warpage level can be reduced is not clear and is currently under investigation.

At present, a variation in temperature distribution during cooling after the ion exchange treatment is presumed to contribute to the warpage. When the tempered glass sheet is rapidly cooled to room temperature immediately after being removed from the ion exchange solution as in the related art, a variation in in-plane temperature distribution of the tempered glass sheet increases, that is, the temperature of an in-plane center portion of the tempered glass sheet becomes higher than that of a peripheral edge portion thereof. Therefore, the tempered glass sheet is liable to be warped due to a difference in thermal expansion. The warpage is eliminated to some degree when the tempered glass sheet is cooled to room temperature to remove the in-plane temperature distribution of the tempered glass sheet, but the warpage is not completely eliminated. When the tempered glass sheet is annealed after the ion exchange treatment as in the invention of the present application, the variation in in-plane temperature distribution of the tempered glass sheet can be decreased during cooling. It should be noted that, although not verified under existing conditions, the following is conceivable. Alkali ions, which are immobilized in a state of being segregated in a surface layer portion of a compressive stress layer during the ion exchange treatment, contribute to the warpage. When the tempered glass sheet is annealed after the ion exchange treatment, the movement of the alkali ions proceeds to gradually eliminate the segregated state of the alkali ions, with the result that the warpage level is improved.

It is known that a glass sheet is not thermally deformed at a temperature equal to or less than its strain point, and the related-art tempered glass sheet has been produced by performing rapid cooling to room temperature after removal from the ion exchange solution. The inventors of the present invention have made extensive studies, and as a result, have found that, in the case of the tempered glass sheet, the warpage level can be reduced unexpectedly even in a temperature environment of less than the strain point and that the warpage level can be reduced by annealing the tempered glass sheet after the ion exchange treatment. The reason that the warpage level can be reduced is not clear and is currently under investigation. The inventors of the present invention presume the following. In the case of the tempered glass sheet, alkali ions, which are immobilized in a state of being segregated in a surface layer portion of a compressive stress layer during the ion exchange treatment, contribute to the warpage. When the tempered glass sheet is annealed after the ion exchange treatment as in the invention of the present application, the movement of the alkali ions proceeds to gradually eliminate the segregated state of the alkali ions, with the result that the warpage level is reduced.

The method of manufacturing a tempered glass sheet of the present invention comprises the arrangement step of arranging a plurality of glass sheets to be tempered, each having a substantially rectangular shape and a sheet thickness of 1.0 mm or less, in a support in an upright posture in a thickness direction at an interval of 10 mm or less, to thereby obtain an arrangement of glass sheets to be tempered. Hitherto, there has been a problem in that, when the glass sheets to be tempered are subjected the ion exchange treatment in a state of being arranged densely, the warpage level of the tempered glass sheets increases. On the other hand, when the tempered glass sheets are annealed after the ion exchange treatment as in the invention of the present application, the warpage level of the tempered glass sheets can be reduced even when the glass sheets to be tempered are arranged densely. As a result, the efficiency of the ion exchange treatment can be improved as compared to that of the related art.

In the method of manufacturing a tempered glass sheet of the present invention, it is preferred that the annealing be performed so that an average warpage ratio of all the tempered glass sheets forming the arrangement of tempered glass sheets is less than 0.5%. Herein, the “average warpage ratio” refers to an average value of warpage ratios of all the tempered glass sheets removed from one support. The “warpage ratio” refers to a value obtained by dividing a maximum displacement amount in a measurement distance by the measurement distance with a laser displacement gauge. For example, the warpage ratio is preferably measured by putting up the tempered glass sheets on a stage in a state of being inclined at 87° with respect to a horizontal plane and scanning a linear measurement region offset by 5 mm from an upper end surface into a plane of the tempered glass sheets.

In the method of manufacturing a tempered glass sheet of the present invention, it is preferred that a cooling time from a temperature of the ion exchange solution to a temperature of 100° C. be 1 minute or more in the annealing step. With this, the warpage level can be reduced easily.

In the method of manufacturing a tempered glass sheet of the present invention, it is preferred that the arrangement of tempered glass sheets be retained at a temperature of 100° C. or more and less than (strain point-100) ° C. during the annealing. With this, the warpage level can be reduced easily, and an ion exchange reaction does not proceed easily due to heat treatment, with the result that a desired compressive stress is obtained easily. Herein, the “strain point” refers to a value measured based on a method of ASTM C336. Further, the term “retained” refers to being maintained in a state of a predetermined temperature±8° C. for a predetermined period of time.

In the method of manufacturing a tempered glass sheet of the present invention, it is preferred that the annealing be performed under a state in which the arrangement of tempered glass sheets is placed in a heat insulating structure. With this, the tempered glass sheets can be cooled gradually, and consequently, the warpage level of the tempered glass sheets can be reduced.

In the method of manufacturing a tempered glass sheet of the present invention, it is preferred that the annealing be performed so that the tempered glass sheets each have a ratio of (internal K emission intensity)/(surface layer K emission intensity) of more than 0.67 and 0.95 or less, that is, when the ratio is represented by R, a relationship of 0.67<R≦0.95 is satisfied. As described above, it is considered that when the concentration gradient of alkali ions is gentle in a surface layer portion of a compressive stress layer, the alkali ions are less segregated. Thus, it is presumed that, when the ratio of (internal K emission intensity)/(surface layer K emission intensity) of the tempered glass sheet is controlled to more than 0.67 and 0.95 or less by annealing, the movement of the alkali ions proceeds to gradually eliminate the segregated state of the alkali ions, with the result that the warpage level is reduced. It should be noted that “(internal K emission intensity)/(surface layer K emission intensity)” represents a ratio of the K emission intensity of an inside (for example, the K emission intensity in a region deeper by 10 μm than a depth of layer) when the reduction in K concentration from a surface to an inside in a depth direction is substantially converged in the case where the K emission intensity on the surface is defined as 1 (in this case, the K emission intensity of a deep portion becomes 0), and can be measured by GD-OES.

In the method of manufacturing a tempered glass sheet of the present invention, it is preferred that air be sent to the arrangement of tempered glass sheets during the annealing. With this, the variation in in-plane temperature distribution of the tempered glass sheets can be suppressed, and consequently, the warpage level of the tempered glass sheets can be reduced.

It is preferred that the method of manufacturing a tempered glass sheet of the present invention further comprise a post-tempering cutting step of cutting each of the tempered glass sheets into a predetermined size after the removal step.

In the method of manufacturing a tempered glass sheet of the present invention, it is preferred that the plurality of glass sheets to be tempered each comprise a glass sheet to be tempered formed by an overflow down-draw method. When the glass sheet to be tempered is formed by the overflow down-draw method, a glass sheet having satisfactory surface quality in an unpolished state can be produced easily, and further, a large thin glass sheet can be produced easily, with the result that the mechanical strength of the surface of a tempered glass can be increased easily. Further, the differences in properties and composition in the vicinity of each of the front surface and the back surface are likely to be reduced, and thus the warpage caused by the differences can be suppressed easily. Herein, the “overflow down-draw method” refers to a method comprising causing a molten glass to overflow from both sides of a heat-resistant trough-shaped structure, and subjecting the overflowing molten glasses to down-draw downward while the molten glasses are joined at the lower end of the trough-shaped structure, to thereby form a glass sheet.

In the method of manufacturing a tempered glass sheet of the present invention, it is preferred that the ion exchange treatment be performed so that a compressive stress of a compressive stress layer of each of the tempered glass sheets is 400 MPa or more, and a depth of layer of the compressive stress layer is 15 μm or more. Herein, the “compressive stress of a compressive stress layer” and “depth of layer of a compressive stress layer” refer to values calculated on the basis of the number of interference fringes observed when a sample is observed using a surface stress meter (for example, FSM-6000 manufactured by Orihara Industrial Co., Ltd.) and intervals therebetween.

In the method of manufacturing a tempered glass sheet of the present invention, it is preferred that the plurality of glass sheets to be tempered each comprise a glass sheet to be tempered comprising 1 mass % to 20 mass % of Na₂O in a glass composition.

In the method of manufacturing a tempered glass sheet of the present invention, it is preferred that the plurality of glass sheets to be tempered each comprise a glass sheet to be tempered comprising as a glass composition, in terms of mass %, 50% to 80% of SiO₂, 5% to 25% of Al₂O₃, 0% to 15% of B₂O₃, 1% to 20% of Na₂O, and 0% to 10% of K₂O. With this, ion exchange performance and denitrification resistance can both be achieved at high levels.

In the method of manufacturing a tempered glass sheet of the present invention, it is preferred that the plurality of glass sheets to be tempered each comprise a glass sheet to be tempered having a strain point of 500° C. or more. With this, the heat resistance of the tempered glass sheet improves, and the warpage level of the tempered glass sheet can be reduced easily.

It is preferred that the method of manufacturing a tempered glass sheet of the present invention be free of a polishing step of polishing a whole or a part of a surface of each of the tempered glass sheets.

It is preferred that the method of manufacturing a tempered glass sheet of the present invention be used for a cover glass of a display device.

An arrangement of glass sheets to be tempered of the present invention, comprises a plurality of glass sheets to be tempered each having a substantially rectangular shape, arranged in a support in an upright posture in a thickness direction at an interval of 10 mm or less.

An arrangement of tempered glass sheets of the present invention comprises a plurality of tempered glass sheets, each having a substantially rectangular shape, arranged in a support in an upright posture in a thickness direction at an interval of 10 mm or less.

In the arrangement of tempered glass sheets of the present invention, it is preferred that an average warpage ratio of all the tempered glass sheets be less than 0.5%.

A tempered glass sheet of the present invention has a substantially rectangular shape, the tempered glass sheet having a sheet thickness of 0.7 mm or less and a warpage ratio of less than 0.5%.

It is preferred that the tempered glass sheet of the present invention have a ratio of (internal K emission intensity)/(surface layer K emission intensity) of more than 0.67 and 0.95 or less.

A support of the present invention is a support for arranging a plurality of tempered glass sheets, each having a substantially rectangular shape and a sheet thickness of 1.0 mm or less, in an upright posture in a thickness direction, the support comprising a support portion for arranging the plurality of tempered glass sheets at an interval of 10 mm or less.

### BRIEF DESCRIPTION OF DRAWINGS

FIG. 1 is a schematic perspective view for illustrating a support for arranging a plurality of glass sheets to be tempered (arrangement of tempered glass sheets) according to one embodiment of the present invention.

FIG. 2 is a schematic perspective view for illustrating a configuration for sending air to the arrangement of tempered glass sheets according to one embodiment of the present invention.

FIG. 3 is a graph for showing data of GD-OES of an alkali component in the vicinity of a surface layer of Sample No. 5 according to [Example 6].

FIG. 4 is a graph for showing data of GD-OES of an alkali component in the vicinity of a surface layer of Sample No. 6 according to [Example 6].

FIG. 5 is a graph for showing data of GD-OES of an alkali component in the vicinity of a surface layer of Sample No. 7 according to [Example 6].

FIG. 6 is a graph for showing data of GD-OES of an alkali component in the vicinity of a surface layer of Sample No. 8 according to [Example 6].

FIG. 7 is a graph for showing data of GD-OES of an alkali component in the vicinity of a surface layer of Sample No. 9 according to [Example 6].

FIG. 8 is a graph for showing data of GD-OES of an alkali component in the vicinity of a surface layer of Sample No. 10 according to [Example 6].

FIG. 9 is a graph for showing data of GD-OES of an alkali component in the vicinity of a surface layer of Sample No. 11 according to [Example 6].

FIG. 10 is a graph for showing data of GD-OES of an alkali component in the vicinity of a surface layer of Sample No. 12 according to [Example 6].

### DESCRIPTION OF EMBODIMENTS

Now, the dimensions of a glass sheet to be tempered (tempered glass sheet) are described.

In a method of manufacturing a tempered glass sheet of the present invention, the sheet thickness of a glass sheet to be tempered is controlled to preferably 1.5 mm or less, 1.0 mm or less, 0.8 mm or less, 0.7 mm or less, 0.6 mm or less, 0.5 mm or less, or less than 0.5 mm, particularly preferably 0.4 mm or less. With this, the weight of a display device can be reduced easily, and in the case of performing post-tempering cutting, a compressive stress is likely to be generated in a cut surface due to the influence of a compressive stress layer in a surface of the tempered glass sheet, with the result that the mechanical strength of the cut surface is less liable to decrease. On the other hand, when the sheet thickness is too small, desired mechanical strength is not obtained easily. Further, the tempered glass sheet is liable to be warped after a tempering step. Thus, the sheet thickness is preferably 0.1 mm or more. It should be noted that, as the sheet thickness is smaller, the tempered glass sheet is more liable to be warped, and hence the effect of the present invention can be exhibited more easily.

The sheet area of the glass sheet to be tempered is controlled to preferably 0.01 m² or more, 0.1 m² or more, 0.25 m² or more, 0.35 m² or more, 0.45 m² or more, 0.8 m² or more, 1 m² or more, 1.2 m² or more, 1.5 m² or more, 2 m² or more, 1.2.5 m² or more, 3 m² or more, 3.5 m² or more, 4 m² or more, or 4.5 m² or more, particularly preferably from 5 m² to 10 m². As the sheet area is larger, the number of pieces to be taken from the tempered glass sheet by post-tempering cutting increases, and the manufacturing efficiency of the tempered glass sheet and various devices dramatically improves. Herein, the “sheet area” refers to the area of a sheet surface excluding an end surface and refers to the area of any one of the front surface or the back surface. It should be noted that, as the sheet area is larger, the tempered glass sheet is more liable to be warped, and hence the effect of the present invention can be exhibited more easily.

In the case of a digital signage application, the sheet area of the tempered glass sheet may be, for example, 1 m² or more. In this case, the variation in in-plane temperature distribution of the tempered glass sheet increases during cooling, and the warpage level of the tempered glass sheet is liable to increase due to the difference in thermal expansion. Thus, in the case of this application, the tempered glass sheet is liable to be warped, and hence the effect of the present invention can be exhibited more easily.

Now, an arrangement step is described.

In the method of manufacturing a tempered glass sheet of the present invention, a plurality of glass sheets to be tempered are arranged in a support at an interval of 10 mm or less. In this case, the arrangement interval is preferably 9 mm or less, 8 mm or less, or 7 mm or less, or is preferably 0.1 mm or more and 6 mm or less or 1 mm or more and less than 5 mm, particularly preferably 1.5 mm or more and less than 3 mm. When the arrangement interval is too large, the manufacturing efficiency of the tempered glass sheet is liable to lower. It should be noted that, when the arrangement interval is too small, there is a risk in that the tempered glass sheets may interfere with each other to cause flaws.

It is preferred that the plurality of glass sheets to be tempered be arranged in the support in a state of being inclined at about from 0° to 20° with respect to a vertical direction or in a state of being inclined at about from 0° to 10° with respect to the vertical direction, particularly preferably in a state of being inclined at about from 0° to 5° with respect to the vertical direction. With this, the ratio of the glass sheets to be tempered received with respect to the support improves.

The support may have any structure as long as the support is capable of receiving the plurality of glass sheets to be tempered at a narrow pitch. It is preferred that the support have a structure comprising, for example, a frame portion, a side edge support portion for supporting a side edge portion of the glass sheets to be tempered, and a lower end support portion for supporting a lower end portion of the glass sheets to be tempered. It is preferred that recessed portions, such as V-grooves, be formed in the side edge support portion and/or the lower end support portion. With this, the glass sheets to be tempered can be supported at a predetermined interval by bringing the glass sheets to be tempered into abutment against the groove portions. It should be noted that the side edge support portion and the lower end support portion are each preferably, for example, a bar-shaped or wire-shaped member having recessed portions.

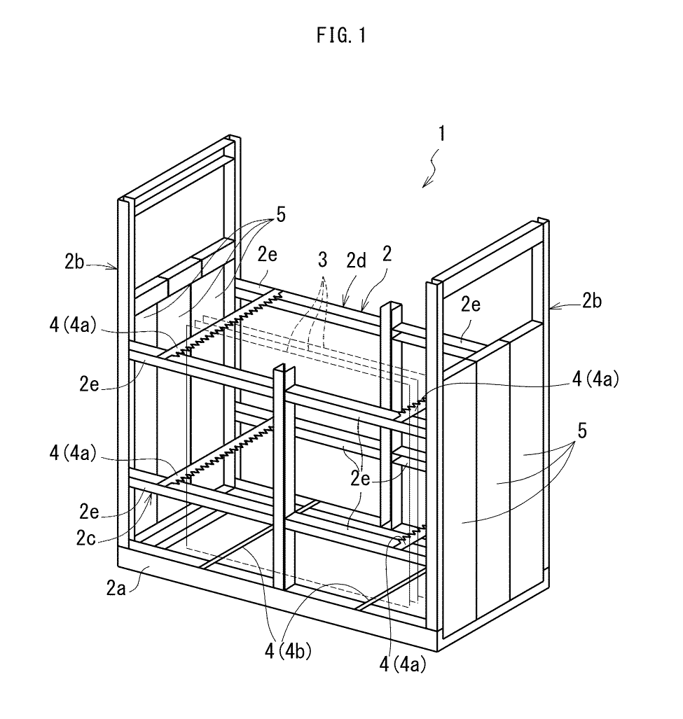

FIG. 1 is a schematic perspective view for illustrating a support for arranging a plurality of glass sheets to be tempered (arrangement of tempered glass sheets) according to one embodiment of the present invention. A support 1 illustrated in FIG. 1 comprises, as main components, a frame portion 2 and support portions 4 for supporting glass sheets to be tempered 3.

The support portions 4 support a plurality of the glass sheets to be tempered 3 in a state in which the glass sheets to be tempered 3 are arranged in an upright posture in a thickness direction at an interval of 10 mm or less. More specifically, the support portions 4 include side edge support portions 4a for supporting a pair of side edge portions of the glass sheets to be tempered 3 and lower end support portions 4b for supporting lower end portions of the glass sheets to be tempered 3.

Both ends of each of the side edge support portions 4a are removably mounted on upper surfaces of beam frame portions 2e with fastening members, such as bolts (not shown). A pair of the side edge support portions 4a for supporting the side edge portions having the same height of the glass sheets to be tempered 3 are mounted on the beam frame portions 2e having the same height. Each of the side edge support portions 4a has recessed portions opposed to the side edge portions of the glass sheets to be tempered 3. The recessed portions are brought into abutment against the side edge portions of the glass sheets to be tempered 3 so as to support the side edge portions, and thus the glass sheets to be tempered 3 are positioned in the thickness direction.

Both ends of each of the lower end support portions 4b are removably mounted on upper surfaces of a pair of long side portions of a bottom frame portion 2a with fastening members, such as bolts (not shown). The lower end support portions 4b merely support the glass sheets to be tempered 3 with upper surfaces and do not have elements such as recessed portions for positioning the glass sheets to be tempered 3 in the thickness direction. It should be noted that the lower end support portions 4b may have elements for positioning the glass sheets to be tempered 3 in the thickness direction.

Heat retention plates 5 are arranged in both-side frame portions 2b and keep the glass sheets to be tempered 3 warm in a state of facing both the side edge portions of the plurality of the glass sheets to be tempered 3 supported by the support portions 4. The heat retention plates 5 may be omitted as necessary. It should be noted that, in this embodiment, the heat retention plates 5 are arranged only on both sides of the plurality of the glass sheets to be tempered 3. Thus, openings are formed respectively in a front frame portion 2c and a back frame portion 2d of the frame portion 2, which respectively face a frontmost surface and a rearmost surface in the thickness direction of the glass sheets to be tempered 3. Further, an opening is also formed in the bottom frame portion 2a located on a lower side of the glass sheets to be tempered 3.

Now, a tempering step is described.

The method of manufacturing a tempered glass sheet of the present invention comprises immersing a glass sheet to be tempered in an ion exchange solution so as to subject the glass sheet to be tempered to ion exchange treatment, to thereby form a compressive stress layer in a surface of the glass sheet to be tempered. The ion exchange treatment is a method comprising introducing alkali ions having a large ion radius into a glass surface at a temperature equal to or less than the strain point of the glass sheet to be tempered. When the ion exchange treatment is performed in the ion exchange solution, even in the case where the sheet thickness is small, a compressive stress layer can be formed appropriately.

The ion exchange solution, an ion exchange temperature, and an ion exchange time may be determined in consideration of, for example, the viscosity characteristics of the glass. In particular, when Na components in the glass sheet to be tempered are subjected to ion exchange treatment with K ions in a KNO₃ molten salt, the compressive stress layer can be efficiently formed in the surface.

It is preferred that the glass sheet to be tempered be subjected to the ion exchange treatment in the ion exchange solution so that a compressive stress of the compressive stress layer becomes 400 MPa or more (desirably 500 MPa or more, 600 MPa or more, or 650 MPa or more, particularly desirably 700 MPa or more), and a depth of layer of the compressive stress layer becomes 15 μm or more (desirably 20 μm or more, 25 μm or more, or 30 μm or more, particularly desirably 35 μm or more). As the compressive stress is larger, the mechanical strength of the tempered glass sheet increases. On the other hand, when the compressive stress is too large, it becomes difficult to subject the tempered glass sheet to scribe cutting. Thus, the compressive stress of the compressive stress layer is preferably 1,500 MPa or less, or 1,200 MPa or less, particularly preferably 1,000 MPa or less. It should be noted that, when the content of Al₂O₃, TiO₂, ZrO₂, MgO, or ZnO is increased in a glass composition, or the content of SrO or BaO is decreased in the glass composition, the compressive stress tends to increase. Further, when the ion exchange time is shortened, or the temperature of the ion exchange solution is decreased, the compressive stress tends to increase.

As the depth of layer is larger, the tempered glass sheet is less liable to be cracked even when the tempered glass sheet has deep flaws, and a variation in mechanical strength decreases. On the other hand, when the depth of layer is too large, it becomes difficult to subject the tempered glass sheet to scribe cutting. The depth of layer is preferably 100 μm or less, less than 80 μm, or 60 μm or less, particularly preferably less than 52 μm. It should be noted that, when the content of K₂O or P₂O₅ is increased in the glass composition, or the content of SrO or BaO is decreased in the glass composition, the depth of layer tends to increase. Further, when the ion exchange time is extended, or the temperature of the ion exchange solution is increased, the depth of layer tends to increase.

Now, an annealing step is described.

The method of manufacturing a tempered glass sheet of the present invention comprises an annealing step of annealing the arrangement of tempered glass sheets after removing the arrangement of tempered glass sheets from the ion exchange solution. It is preferred that the arrangement of tempered glass sheets be annealed continuously after being removed from the ion exchange solution, and it is preferred that a heat insulating structure be arranged in an upper portion of an ion exchange chamber, and the arrangement of tempered glass sheets be annealed immediately after being removed upward from the ion exchange solution. With this, the manufacturing efficiency of the tempered glass sheet improves, and the warpage level of the tempered glass sheet can be reduced easily.

In the method of manufacturing a tempered glass sheet of the present invention, the temperature is decreased preferably at a temperature decrease rate of 25° C./min or less or 20° C./min or less in a temperature range of 150° C. or more and less than the strain point, and the temperature decrease time in this case is preferably 3 minutes or more, 5 minutes or more, 7 minutes or more, or 10 minutes or more. When the temperature decrease rate is increased, the warpage level of the tempered glass sheet is less likely to be reduced. Further, when the temperature decrease time is shortened, the warpage level of the tempered glass sheet is less likely to be reduced.

It is preferred that the annealing be performed so that the average warpage ratio of a plurality of tempered glass sheets becomes less than 0.5%, 0.3% or less, less than 0.23%, 0.2% or less, 0.18% or less, less than 0.15%, or 0.13% or less, particularly preferably less than 0.10%. When the average warpage ratio is large, the manufacturing yield of the tempered glass sheet is liable to decrease. It should be noted that it is also preferred that the annealing be performed so that the warpage ratio of each tempered glass sheet becomes 0.3% or less, less than 0.23%, 0.2% or less, 0.18% or less, less than 0.15%, or 0.13% or less, particularly preferably less than 0.10%. When the warpage ratio is large, the manufacturing yield of the tempered glass sheet is liable to decrease.

The cooling time from the temperature of the ion exchange solution to a temperature of 100° C. is preferably 1 minute or more, 3 minutes or more, 5 minutes or more, from 10 minutes to 250 minutes, or from 12 minutes to 200 minutes, particularly preferably from 15 minutes to 90 minutes. When the cooling time is too short, the warpage level of the tempered glass sheet is less likely to be reduced. On the other hand, when the cooling time is too long, the manufacturing efficiency of the tempered glass sheet is liable to lower, and the ion exchange reaction proceeds during cooling, with the result that the compressive stress is liable to decrease. It should be noted that the “cooling” is a combined concept of annealing and rapid cooling.

It is preferred that the annealing be performed in a temperature range of 100° C. or more and less than (strain point-100) ° C., or a temperature range of 150° C. or more and less than (strain point-150) ° C., particularly preferably a temperature range of 200° C. or more and less than (strain point-200°) C. When the annealing temperature range is too low, the warpage level of the tempered glass sheet is less likely to be reduced. On the other hand, when the annealing temperature range is too high, the ion exchange reaction proceeds during the annealing, with the result that the compressive stress is liable to decrease. The annealing time is preferably 1 minute or more, 3 minutes or more, 5 minutes or more, from 10 minutes to 250 minutes, or from 2 minutes to 200 minutes, particularly preferably from 15 minutes to 90 minutes. When the annealing time is too short, the warpage level of the tempered glass sheet is less likely to be reduced. On the other hand, when the annealing time is too long, the manufacturing efficiency of the tempered glass sheet is liable to lower, and the ion exchange reaction proceeds during the annealing, with the result that the compressive stress is liable to decrease.

It is preferred that the arrangement of tempered glass sheets be retained at a temperature of 100° C. or more and less than (strain point-100°) C., or a temperature of 150° C. or more and less than (strain point-150°) C., particularly preferably a temperature of 200° C. or more and less than (strain point-200°) C. during the annealing. When the retention temperature is too low, the warpage level of the tempered glass sheet is less likely to be reduced. On the other hand, when the retention temperature is too high, the ion exchange reaction proceeds during the annealing, with the result that the compressive stress is liable to decrease. The retention time is preferably 1 minute or more, 3 minutes or more, 5 minutes or more, from 10 minutes to 250 minutes, or from 12 minutes to 200 minutes, particularly preferably from 15 minutes to 90 minutes. When the retention time is too short, the warpage level of the tempered glass sheet is less likely to be reduced. On the other hand, when the retention time is too long, the manufacturing efficiency of the tempered glass sheet is liable to lower, and the ion exchange reaction proceeds during the annealing, with the result that the compressive stress is liable to decrease.

It is preferred to provide a step of rapidly cooling the arrangement of tempered glass sheets to a temperature of less than 100° C. after the annealing. In this case, the temperature decrease rate is preferably more than 30° C./min, particularly preferably 50° C./min or more. With this, the manufacturing efficiency of the tempered glass sheet can be improved while the warpage level of the tempered glass sheet is improved.

A step of increasing the temperature by 20° C. or more, or 30° C. or more, particularly 40° C. or more may be provided after the annealing. However, when the step is provided, the manufacturing efficiency of the tempered glass sheet is liable to lower, and the ion exchange reaction proceeds during the increase in temperature, with the result that the compressive stress is liable to decrease.

In the method of manufacturing a tempered glass sheet of the present invention, it is preferred that the annealing be performed under a state in which the arrangement of tempered glass sheets is placed in the heat insulating structure. With this, the arrangement of tempered glass sheets is gradually cooled, and the warpage level of the tempered glass sheet is likely to be reduced. It is preferred that the heat insulating structure have heating means, such as a heater. Specifically, an annealing furnace or the like can be used. With this, the temperature decrease rate can be controlled easily. Further, the heat insulating structure is not necessarily air-tight completely and may have an opening.

In the method of manufacturing a tempered glass sheet of the present invention, it is preferred that the annealing be performed so that the tempered glass sheet has a ratio of (internal K emission intensity)/(surface layer K emission intensity) of more than 0.67 and 0.95 or less. The lower limit ratio of the (internal K emission intensity)/(surface layer K emission intensity) is suitably 0.68 or more, 0.70 or more, 0.72 or more, or 0.74 or more, particularly suitably 0.75 or more, and the upper limit ratio thereof is suitably 0.92 or less, 0.90 or less, or 0.88 or less, particularly suitably 0.86 or less. When the (internal K emission intensity)/(surface layer K emission intensity) is too large, the alkali ions are immobilized in a state of being segregated in a surface layer portion of the compressive stress layer, and hence the warpage level of the tempered glass sheet is liable to increase. On the other hand, when the (internal K emission intensity)/(surface layer K emission intensity) is too small, the compressive stress is liable to decrease, and it becomes difficult to maintain the mechanical strength.

In the method of manufacturing a tempered glass sheet of the present invention, it is preferred that air be sent to the arrangement of tempered glass sheets during the annealing. It is more preferred that air be sent toward each gap between the tempered glass sheets. It is still more preferred that air be sent toward each gap between the tempered glass sheets from below. With this, the variation in in-plane temperature distribution of the tempered glass sheets decreases, and the warpage level of the tempered glass sheets can be reduced. It should be noted that, when cold air is sent to the arrangement of tempered glass sheets, the tempered glass sheets can be cooled while the variation in in-plane temperature distribution of the tempered glass sheets is decreased. When hot air is sent to the arrangement of tempered glass sheets, the tempered glass sheets can be annealed while the variation in in-plane temperature distribution of the tempered glass sheets is decreased. It should be noted that a well-known air blower (such as a fan or a blower) can be used as air-sending means.

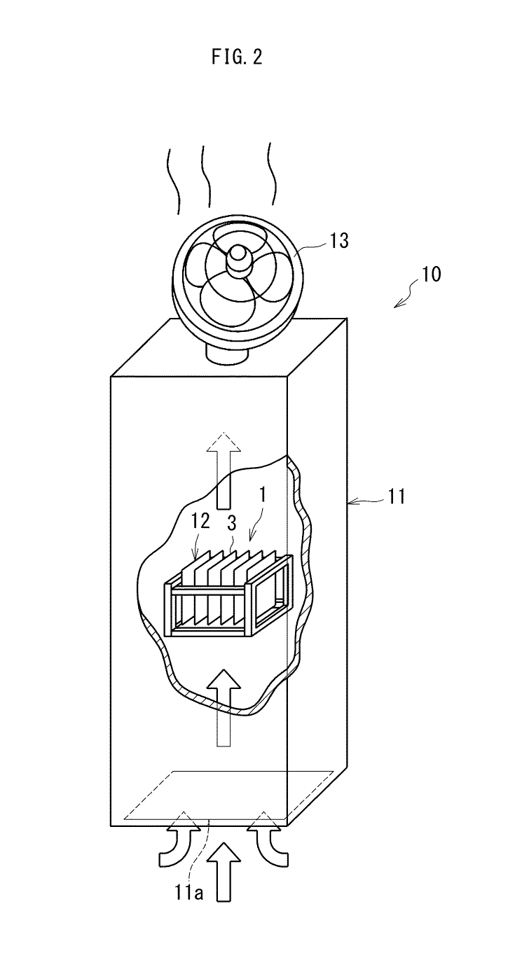

FIG. 2 is a schematic perspective view for illustrating an air-sending device for sending air to the arrangement of tempered glass sheets during the annealing according to one embodiment of the present invention. As illustrated in FIG. 2, an air-sending device 10 has such a configuration that an arrangement of tempered glass sheets 12, which includes a plurality of tempered glass sheets 3 arranged in an upright posture in the support 1 with a gap interposed therebetween, is held in an internal space of a tubular (square tube shaped) enclosure 11 in which gas is capable of being distributed in an up-and-down direction. Air-sending means 13, such as a fan or a blower, is arranged in an upper end portion of the enclosure 10, and an opening 11a is formed in a lower end portion of the enclosure 10. The air-sending device 10 is configured so that gas having flowed into the internal space from the opening 11a in the lower end portion of the enclosure 11 along with the drive of the air-sending means 13 passes through a mounting section of the arrangement of tempered glass sheets 12 to flow upward as denoted by the arrow and flows out from the upper end portion of the enclosure 10. It should be noted that the gas is air but may be inert gas, such as nitrogen or argon.

With such configuration, the gas flowing upward through the internal space of the enclosure 11 is brought into contact with a front surface and a back surface of each of the tempered glass sheets 3 forming the arrangement of tempered glass sheets 12. In this case, the flow direction of the gas in the internal space of the enclosure 11 is parallel to the front surface and the back surface of each of the tempered glass sheets 3, and hence large air flow resistance does not occur. It should be noted that, instead of the above-mentioned configuration, the gas may be caused to flow upward in the internal space of the enclosure 11 by arranging the air-sending means 13 in the lower end portion of the enclosure 11 and forming the opening 11a in the upper end portion of the enclosure 11. Further, air may be sent toward the arrangement of tempered glass sheets 12 by air-sending means provided separately in a state in which the arrangement of tempered glass sheets 12 is exposed together with the support 1, without providing the enclosure 11. Further, it is preferred that the gas flow upward as the flow direction of the gas, but a flow of gas directed downward may be generated.

Now, a removal step is described.

The method of manufacturing a tempered glass sheet of the present invention comprises a removal step of removing the tempered glass sheet from the support. The temperature of the tempered glass sheet when being removed (or the environmental temperature) is preferably less than 100° C., particularly preferably 50° C. or less. With this, a situation in which the tempered glass sheet is broken due to thermal shock at a time of being removed can be prevented easily.

Now, a glass to be tempered is described.

In the method of manufacturing a tempered glass sheet of the present invention, it is preferred that the glass sheet to be tempered be formed by an overflow down-draw method. With this, a glass sheet having satisfactory surface quality in an unpolished state can be formed easily, and consequently, the mechanical strength of the surface of the tempered glass sheet can be increased easily. This is because in the case of the overflow down-draw method, a surface which is to serve as a surface of the glass sheet is formed in a state of a free surface without being brought into contact with a trough-shaped refractory. The structure and material of the trough-shaped structure are not particularly limited as long as desired dimensions and surface quality can be achieved. In addition, a method of applying a force to a glass ribbon in order to down-draw the glass ribbon downward is not particularly limited as long as desired dimensions and surface quality can be achieved. For example, there may be adopted a method comprising rotating a heat-resistant roll having a sufficiently large width in the state of being in contact with the glass ribbon, to thereby draw the glass, or there may be adopted a method comprising bringing a plurality of paired heat-resistant rolls into contact with only the vicinity of the end surfaces of the glass ribbon, to thereby draw the glass ribbon.

The glass to be tempered may be formed by a method other than the overflow down-draw method, such as a slot down-draw method, a float method, a roll-out method, or a re-draw method.

In the method of manufacturing a tempered glass sheet of the present invention, it is preferred that the glass sheet to be tempered be produced so as to comprise 1 mass % to 20 mass % of Na₂O in its glass composition. Na₂O is a main ion exchange component, and is also a component which lowers the viscosity at high temperature to increase meltability and formability. Further, Na₂O is a component which improves devitrification resistance. However, when the content of Na₂O is too small, the meltability lowers, the thermal expansion coefficient becomes low, and the ion exchange performance is liable to lower. On the other hand, when the content of Na₂O is too large, the thermal expansion coefficient becomes too high, with the result that the thermal shock resistance lowers and it becomes difficult to match the thermal expansion coefficient with those of peripheral materials. Further, in some cases, the strain point excessively lowers, and the glass composition loses its component balance, with the result that the denitrification resistance lowers contrarily.

In the method of manufacturing a tempered glass sheet of the present invention, it is preferred that the glass sheet to be tempered be produced so as to comprise as a glass composition, in terms of mass %, 50% to 80% of SiO₂, 5% to 25% of Al₂O₃, 0% to 15% of B₂O₃, 1% to 20% of Na₂O, and 0% to 10% of K₂O. The reason why the content range of each component is limited as described above is described below. It should be noted that the expression “%” refers to “mass %” in the following description of the content range of each component.

SiO₂ is a component which forms a network of a glass. The content of SiO₂ is preferably from 50% to 80%, from 52% to 75%, from 55% to 72%, or from 55% to 70%, particularly preferably from 55% to 67.5%. When the content of SiO₂ is too small, vitrification does not occur easily. Further, the thermal expansion coefficient becomes too high, and the thermal shock resistance is liable to lower. On the other hand, when the content of SiO₂ is too large, the meltability and formability are liable to lower.

Al₂O₃ is a component which increases the ion exchange performance, and is also a component which increases the strain point and a Young's modulus. The content of Al₂O₃ is preferably from 5% to 25%. When the content of Al₂O₃ is too small, the thermal expansion coefficient becomes too high, and the thermal shock resistance is liable to lower. In addition, sufficient ion exchange performance may not be exhibited. Thus, the lower limit range of Al₂O₃ is suitably 7% or more, 8% or more, 10% or more, 12% or more, 14% or more, or 15% or more, particularly suitably 16% or more. On the other hand, when the content of Al₂O₃ is too large, a devitrified crystal is liable to deposit in the glass and it becomes difficult to form a glass sheet by the overflow down-draw method. Further, the thermal expansion coefficient becomes too low, with the result that it becomes difficult to match the thermal expansion coefficient with those of peripheral materials. In addition, the viscosity at high temperature rises, and the meltability is liable to lower. Thus, the upper limit range of Al₂O₃ is suitably 22% or less, 20% or less, 19% or less, or 18% or less, particularly suitably 17% or less. It should be noted that, in the case where the ion exchange performance is considered to be important, it is preferred to increase the content of Al₂O₃ to the extent possible, and for example, the content of Al₂O₃ is preferably 17% or more, 18% or more, 19% or more, or 20% or more, particularly preferably 21% or more.

B₂O₃ is a component which lowers the viscosity at high temperature and the density, and stabilizes a glass to make it difficult for a crystal to deposit and lowers the liquidus temperature. Further, B₂O₃ is a component which increases crack resistance. However, when the content of B₂O₃ is too large, there are tendencies that the coloring of a surface called weathering occurs due to ion exchange treatment, water resistance lowers, the compressive stress of the compressive stress layer lowers, and the depth of layer of the compressive stress layer lowers. Thus, the content of B₂O₃ is preferably from 0% to 15%, from 0.1% to 12%, from 1% to 10%, from more than 1% to 8%, or from 1.5% to 6%, particularly preferably from 2% to 5%. It should be noted that in the case where the ion exchange performance is considered to be important, it is preferred to increase the content of B₂O₃ to the extent possible, and for example, the content of B₂O₃ is preferably 2.5% or more, 3% or more, 3.5% or more, 4% or more, particularly preferably 4.5% or more.

Na₂O is a main ion exchange component, and is also a component which lowers the viscosity at high temperature to increase the meltability and the formability. Further, Na₂O is also a component improving denitrification resistance. The content of Na₂O is preferably from 1% to 20%. When the content of Na₂O is too small, the meltability lowers, the thermal expansion coefficient becomes low, and the ion exchange performance is liable to lower. Thus, in the case of introducing Na₂O, the lower limit range of Na₂O is suitably 10% or more, or 11% or more, particularly suitably 12% or more. On the other hand, when the content of Na₂O is too large, the thermal expansion coefficient becomes too high, with the result that the thermal shock resistance lowers and it becomes difficult to match the thermal expansion coefficient with those of peripheral materials. Further, in some cases, the strain point excessively lowers, and the glass composition loses its component balance, with the result that the devitrification resistance lowers contrarily. Thus, the upper limit range of Na₂O is suitably 17% or less, particularly suitably 16% or less.

K₂O is a component which promotes ion exchange, and has a high effect of increasing the depth of layer of the compressive stress layer among alkali metal oxides. Further, K₂O is a component which lowers the viscosity at high temperature to increase the meltability and the formability. K₂O is also a component which improves the devitrification resistance. The content of K₂O is from 0% to 10%. When the content of K₂O is too large, the thermal expansion coefficient becomes too high, with the result that the thermal shock resistance lowers and it becomes difficult to match the thermal expansion coefficient with those of peripheral materials. Further, there are tendencies that the strain point excessively lowers, and the glass composition loses its component balance, with the result that the devitrification resistance lowers contrarily. Therefore, the upper limit range of K₂O is suitably 8% or less, 6% or less, or 4% or less, particularly suitably less than 2%.

In addition to the components described above, for example, the following components may be added.

Li₂O is an ion exchange component, and is also a component which lowers the viscosity at high temperature to increase the meltability and the formability. Further, Li₂O is a component which increases the Young's modulus. Further, Li₂O has a high effect of increasing the compressive stress among alkali metal oxides. However, when the content of Li₂O is too large, the liquidus viscosity lowers and the glass is liable to be devitrified. Further, the thermal expansion coefficient becomes too high, with the result that the thermal shock resistance lowers and it becomes difficult to match the thermal expansion coefficient with those of peripheral materials. Further, when the viscosity at low temperature excessively lowers and stress relaxation easily occurs, the compressive stress may lower contrarily. Therefore, the content of Li₂O is preferably from 0% to 3.5%, from 0% to 2%, from 0% to 1%, or from 0% to 0.5%, particularly preferably from 0.01% to 0.2%

The content of Li₂O+Na₂O+K₂O is suitably from 5% to 25%, from 10% to 22%, or from 15% to 22%, particularly suitably from 17% to 22%. When the content of Li₂O+Na₂O+K₂O is too small, the ion exchange performance and the meltability are liable to lower. On the other hand, when the content of Li₂O+Na₂O+K₂O is too large, the glass is liable to be devitrified. In addition, the thermal expansion coefficient becomes too high, with the result that the thermal shock resistance lowers and it becomes difficult to match the thermal expansion coefficient with those of peripheral materials. Further, the strain point excessively lowers, and a high compressive stress is not obtained easily in some cases. Further, the viscosity around the liquidus temperature lowers, and it becomes difficult to secure a high liquidus viscosity in some cases. It should be noted that “Li₂O+Na₂O+K₂O” is the total content of Li₂O, Na₂O, and K₂O.

MgO is a component which lowers the viscosity at high temperature to increase the meltability and the formability, or to increase the strain point and the Young's modulus, and has a high effect of increasing the ion exchange performance among alkaline earth metal oxides. However, when the content of MgO becomes too large, the density and the thermal expansion coefficient are liable increase, and the glass is liable to be devitrified. Thus, the upper limit range of MgO is suitably 12% or less, 10% or less, 8% or less, or 5% or less, particularly suitably 4% or less. It should be noted that, in the case where MgO is introduced into the glass composition, the lower limit range of MgO is suitably 0.1% or more, 0.5% or more, or 1% or more, particularly suitably 2% or more.

CaO has a high effect of lowering the viscosity at high temperature to increase the meltability and the formability or to increase the strain point and the Young's modulus, without lowering the denitrification resistance as compared to the other components. The content of CaO is preferably from 0% to 10%. However, when the content of CaO is too large, the density and the thermal expansion coefficient increase, the glass composition loses its component balance, with the result that the glass is liable to be devitrified contrarily, and the ion exchange performance is liable to lower. Thus, the content of CaO is suitably from 0% to 5%, from 0.01% to 4%, or from 0.1% to 3%, particularly suitably from 1% to 2.5%.

SrO is a component which lowers the viscosity at high temperature to increase the meltability and the formability, or to increase the strain point and the Young's modulus, without lowering the devitrification resistance. However, when the content of SrO is too large, the density and the thermal expansion coefficient increase, the ion exchange performance lowers, and the glass composition loses its component balance, with the result that the glass is liable to be devitrified contrarily. The content range of SrO is suitably from 0% to 5%, from 0% to 3%, or from 0% to 1%, particularly suitably from 0% to less than 0.1%.

BaO is a component which lowers the viscosity at high temperature to increase the meltability and the formability, or to increase the strain point and the Young's modulus, without lowering the devitrification resistance. However, when the content of BaO is too large, the density and the thermal expansion coefficient increase, the ion exchange performance lowers, and the glass composition loses its component balance, with the result that the glass is liable to be devitrified contrarily. The content range of BaO is suitably from 0% to 5%, from 0% to 3%, or from 0% to 1%, particularly suitably from 0% to less than 0.1%.

ZnO is a component which increases the ion exchange performance, and in particular, is a component which has a high effect of increasing the compressive stress. Further, ZnO is a component which lowers the viscosity at high temperature without lowering the viscosity at low temperature. However, when the content of ZnO is too large, there are tendencies that the glass manifests phase separation, the devitrification resistance lowers, the density increases, and the depth of layer of the compressive stress layer lowers. Thus, the content of ZnO is preferably from 0% to 6%, from 0% to 5%, from 0% to 1%, or from 0% to 0.5%, particularly preferably from 0% to less than 0.1%.

ZrO₂ is a component which remarkably increases the ion exchange performance and simultaneously increases the viscosity around the liquidus viscosity and the strain point. However, when the content of ZrO₂ is too large, the devitrification resistance may remarkably lower, and the density may excessively increase. Thus, the upper limit range of ZrO₂ is suitably 10% or less, 8% or less, or 6% or less, particularly suitably 5% or less. It should be noted that, in the case where it is intended to increase the ion exchange performance, it is preferred that ZrO₂ be introduced into the glass composition, and in this case, the lower limit range of ZrO₂ is suitably 0.01% or more, or 0.5%, particularly suitably 1% or more.

P₂O₅ is a component which increases the ion exchange performance, and in particular, is a component which increases the depth of layer of the compressive stress layer. However, when the content of P₂O₅ is too large, the glass is liable to manifest phase separation. Thus, the upper limit range of P₂O₅ is suitably 10% or less, 8% or less, 6% or less, 4% or less, 2% or less, or 1% or less, particularly suitably less than 0.1%.

As a fining agent, one kind or two or more kinds selected from the group consisting of As₂O₃, Sb₂O₃, SnO₂, F, Cl, and SO₃ (preferably the group consisting of SnO₂, Cl, and SO₃) may be introduced in an amount of from 0 ppm to 30,000 ppm (3%). From the viewpoint of exhibiting the fining effect reliably, the content of SnO₂+SO₃+Cl is preferably from 0 ppm to 10,000 ppm, from 50 ppm to 5,000 ppm, from 80 ppm to 4,000 ppm, or from 100 ppm to 3,000 ppm, particularly preferably from 300 ppm to 3,000 ppm. Herein, the “SnO₂+SO₃+Cl” refers to the total content of SnO₂, SO₃, and Cl.

The content range of SnO₂ is suitably from 0 ppm to 10,000 ppm, or from 0 ppm to 7,000 ppm, particularly suitably from 50 ppm to 6,000 ppm. The content range of Cl is suitably from 0 ppm to 1,500 ppm, from 0 ppm to 1,200 ppm, from 0 ppm to 800 ppm, or from 0 ppm to 500 ppm, particularly suitably from 50 ppm to 300 ppm. The content range of SO₃ is suitably from 0 ppm to 1,000 ppm, or from 0 ppm to 800 ppm, particularly suitably from 10 ppm to 500 ppm.

Rare earth oxides, such as Nd₂O₃ and La₂O₃, are components which increase the Young's modulus, and are also components which can control the color of the glass by being decolored when added with a color serving as a complementary color. However, the cost of the raw material itself is high, and when the rare earth oxides are introduced in large amounts, the denitrification resistance is liable to lower. Therefore, the content of the rare earth oxides is preferably 4% or less, 3% or less, 2% or less, or 1% or less, particularly preferably 0.5% or less.

In the present invention, from the viewpoint of the environment, it is preferred that the contents of As₂O₃, F, PbO, and Bi₂O₃ be substantially zero. Herein, the “content of As₂O₃ is substantially zero” is intended to mean that As₂O₃ is not added actively as a glass component but the case of mixing As₂O₃ at an impurity level is allowed, and specifically refers to that the content of As₂O₃ is less than 500 ppm. The “content of F is substantially zero” is intended to mean that F is not added actively as a glass component but the case of mixing F at an impurity level is allowed, and specifically refers to that the content of F is less than 500 ppm. The “content of PbO is substantially zero” is intended to mean that PbO is not added actively as a glass component but the case of mixing PbO at an impurity level is allowed, and specifically refers to that the content of PbO is less than 500 ppm. The “content of Bi₂O₃ is substantially zero” is intended to mean that Bi₂O₃ is not added actively as a glass component but the case of mixing Bi₂O₃ at an impurity level is allowed, and specifically refers to that the content of Bi₂O₃ is less than 500 ppm.

It is preferred that the glass to be tempered be produced so as to have the following characteristics.

The density of the glass to be tempered is preferably 2.6 g/cm³ or less, particularly preferably 2.55 g/cm³ or less. As the density becomes smaller, the weight of the tempered glass sheet can be reduced more. It should be noted that the density is easily reduced by increasing the content of SiO₂, B₂O₃, or P₂O₅ in the glass composition or by reducing the content of an alkali metal oxide, an alkaline earth metal oxide, ZnO, ZrO₂, or TiO₂ in the glass composition. It should be noted that the “density” may be measured by a well-known Archimedes method.

The thermal expansion coefficient of the glass to be tempered is preferably 80×10⁻⁷/° C. to 120×10⁻⁷/° C., from 85×10⁻⁷/° C. to 110×10⁻⁷/° C., or from 90×10⁻⁷/° C. to 110×10⁻⁷/° C., particularly preferably from 90×10⁻⁷/° C. to 105×10⁻⁷/° C. When the thermal expansion coefficient is controlled within the above-mentioned ranges, it becomes easy to match the thermal expansion coefficient with those of members made of a metal, an organic adhesive, and the like, and the members made of a metal, an organic adhesive, and the like are easily prevented from being peeled off. Herein, the “thermal expansion coefficient” refers to a value obtained through measurement of an average thermal expansion coefficient in the temperature range of from 30° C. to 380° C. with a dilatometer. It should be noted that the thermal expansion coefficient is easily increased by increasing the content of SiO₂, Al₂O₃, B₂O₃, an alkali metal oxide, or an alkaline earth metal oxide in the glass composition, and in contrast, the thermal expansion coefficient is easily decreased by reducing the content of the alkali metal oxide or the alkaline earth metal oxide.

The strain point of the glass to be tempered is preferably 500° C. or more, 520° C. or more, or 530° C. or more, particularly preferably 550° C. or more. As the strain point becomes higher, the heat resistance is improved more, and the tempered glass sheet is less liable to be warped. Further, a high-quality film can be easily formed in patterning to form a touch panel sensor or the like. It should be noted that the strain point is easily increased by increasing the content of an alkaline earth metal oxide, Al₂O₃, ZrO₂, or P₂O₅ in the glass composition or by reducing the content of an alkali metal oxide in the glass composition.

The temperature at 10^{4.0} dPa·s of the glass to be tempered is preferably 1,280° C. or less, 1,230° C. or less, 1,200° C. or less, or 1,180° C. or less, particularly preferably 1,160° C. or less. Herein, the “temperature at 10^{4.0} dPa·s” refers to a value obtained by measurement using a platinum sphere pull up method. As the temperature at 10^{4.0} dPa·s becomes lower, a burden on forming equipment is reduced more, the forming equipment has a longer life, and consequently, the manufacturing cost of the glass sheet to be tempered is more likely to be reduced. It should be noted that the temperature at 10^{4.0} dPa·s is easily decreased by increasing the content of an alkali metal oxide, an alkaline earth metal oxide, ZnO, B₂O₃, or TiO₂ or by reducing the content of SiO₂ or Al₂O₃.

The temperature at 10^{2.5} dPa·s of the glass to be tempered is preferably 1,620° C. or less, 1,550° C. or less, 1,530° C. or less, or 1,500° C. or less, particularly preferably 1,450° C. or less. Herein, the “temperature at 10^{2.5} dPa·s” refers to a value obtained by measurement using a platinum sphere pull up method. As the temperature at 10^{2.5} dPa·s becomes lower, melting at lower temperature can be carried out, and hence a burden on glass manufacturing equipment such as a melting furnace is reduced more, and the bubble quality is easily improved more. Thus, as the temperature at 10^{2.5} dPa·s becomes lower, the manufacturing cost of the glass sheet to be tempered is more likely to be reduced. It should be noted that the temperature at 10^{2.5} dPa·s corresponds to a melting temperature. Further, the temperature at 10^{2.5} dPa·s is easily decreased by increasing the content of an alkali metal oxide, an alkaline earth metal oxide, ZnO, B₂O₃, or TiO₂ in the glass composition or by reducing the content of SiO₂ or Al₂O₃ in the glass composition.

The liquidus temperature of the glass to be tempered is preferably 1,200° C. or less, 1,150° C. or less, 1,100° C. or less, 1,050° C. or less, 1,000° C. or less, 950° C. or less, or 900° C. or less, particularly preferably 880° C. or less. Herein, the “liquidus temperature” refers to a temperature at which crystals deposit when glass powder which has passed through a standard 30-mesh sieve (sieve opening: 500 μm) and remained on a 50-mesh sieve (sieve opening: 300 μm) is placed in a platinum boat and kept in a gradient heating furnace for 24 hours. It should be noted that as the liquidus temperature becomes lower, the denitrification resistance and the formability are improved more. Further, the liquidus temperature is easily decreased by increasing the content of Na₂O, K₂O, or B₂O₃ in the glass composition or by reducing the content of Al₂O₃, Li₂O, MgO, ZnO, TiO₂, or ZrO₂ in the glass composition.

The liquidus viscosity of the glass to be tempered is preferably 10^{4.0} dPa·s or more, 10^{4.4} dPa·s or more, 10^{4.8} dPa·s or more, 10^{5.0} dPa·s or more, 10^{5.4} dPa·s or more, 10^{5.6} dPa·s or more, 10^{6.0} dPa·s or more, or 10^{6.2} dPa·s or more, particularly preferably 10^{6.3} dPa·s or more. Herein, the “liquidus viscosity” refers to a value obtained through measurement of a viscosity at the liquidus temperature by a platinum sphere pull up method. It should be noted that as the liquidus viscosity becomes higher, the denitrification resistance and the formability are improved more. Further, the liquidus viscosity is easily increased by increasing the content of Na₂O or K₂O in the glass composition or by reducing the content of Al₂O₃, Li₂O, MgO, ZnO, TiO₂, or ZrO₂ in the glass composition.

The β-OH value of the glass to be tempered is preferably 0.45 mm⁻¹ or less, 0.4 mm⁻¹ or less, 0.3 mm⁻¹ or less, 0.28 mm⁻¹ or less, or 0.25 mm⁻¹ or less, particularly preferably from 0.10 mm⁻¹ to 0.22 mm⁻¹. As the β-OH value is smaller, the strain point increases, and the ion exchange performance improves. Herein, the “β-OH value” refers to a value determined with the following expression by measuring a transmittance of a glass through use of FT-IR.

β-OH value=(1/X) log(T₁/T₂)

X: Sample thickness (mm)

T₁: Transmittance (%) at a reference wavelength of 3,846 cm⁻¹

T₂: Minimum transmittance (%) around a hydroxy group absorption wavelength of 3,600 cm⁻¹

As a method of decreasing the β-OH value, for example, there are given the following methods (1) to (7). (1) A raw material having a low water content is selected. (2) Water is not added to a raw material. (3) The addition amount of components (such as Cl and SO₃) for reducing a water content is increased. (4) The water content in an atmosphere in a furnace is reduced. (5) N₂ bubbling is performed in a molten glass. (6) A small melting furnace is adopted. (7) The flow rate of a molten glass is increased.

Now, a polishing step, a cutting step, and the like are described.

It is preferred that the method of manufacturing a tempered glass sheet of the present invention be free of a step of polishing the surface of the tempered glass sheet. In addition, it is desirable to control the average surface roughness (Ra) of the unpolished surface of the tempered glass sheet to preferably 10 Å or less, more preferably 5 Å or less, more preferably 4 Å or less, still more preferably 3 Å or less, most preferably 2 Å or less. It should be noted that the average surface roughness (Ra) may be measured by a method in conformity with SEMI D7-97 “FPD Glass Substrate Surface Roughness Measurement Method.” Glass originally has extremely high theoretical strength, but often breaks even under a stress far lower than the theoretical strength. This is because a small flaw called a Griffith flaw is generated in a glass surface in a step after forming, such as a polishing step. Therefore, when the surface of the tempered glass sheet is left unpolished, the mechanical strength of the tempered glass sheet is maintained after the ion exchange treatment and the tempered glass sheet hardly undergoes breakage. In addition, in the case of performing scribe cutting after the ion exchange treatment, when the surface is left unpolished, an improper crack, breakage, or the like is hardly generated at the time of the scribe cutting. Further, when the surface of the tempered glass sheet is left unpolished, the polishing step can be omitted, and hence the manufacturing cost of the tempered glass sheet can be reduced. It should be noted that in order to obtain the unpolished surface, it is recommended to form the glass sheet to be tempered by an overflow down-draw method.

In the method of manufacturing a tempered glass sheet of the present invention, there is no particular limitation on when the tempered glass sheet is cut into a predetermined size. However, when a step of cutting the tempered glass sheet into a predetermined size is provided after the ion exchange treatment, that is, post-tempering cutting is performed, the tempered glass sheet having a warpage level reduced during the annealing step is cut, and hence the efficiency of the post-tempering cutting is improved easily. As a result, the manufacturing efficiency of the tempered glass sheet can be improved. Further, it is also preferred to provide the step of cutting the tempered glass sheet into a predetermined size before the ion exchange treatment. With this, the dimensions of the glass sheet to be tempered are reduced, and hence the warpage level of the tempered glass sheet can be reduced easily.

In the method of manufacturing a tempered glass sheet of the present invention, it is preferred that post-tempering scribe cutting be performed from the viewpoint of the manufacturing efficiency of the tempered glass sheet. In the case where the tempered glass sheet is subjected to scribe cutting, it is preferred that the depth of a scribe line be larger than a stress thickness, and an internal tensile stress be 80 MPa or less (desirably 70 MPa or less, 60 MPa or less, 50 MPa or less). Further, it is preferred that scribing be started from a region which is away from an end surface of the tempered glass sheet to an inner side by 5 mm or more, and it is preferred that the scribing be ended in a region which is away from an opposing end surface to the inner side by 5 mm or more. With this, unintended cracks are less liable to occur during the scribing, and the post-tempering scribe cutting can be easily performed appropriately. Herein, the internal tensile stress is a value calculated by the following expression.

Internal tensile stress=(Compressive stress×Depth of layer)/(Thickness−Depth of layer×2)

In the case where the post-tempering scribe cutting is performed, it is preferred that a scribe line be formed on a surface of the tempered glass sheet, and the tempered glass sheet be divided along the scribe line. With this, unintended cracks are less liable to develop during the cutting. In order to divide the tempered glass sheet along the scribe line, it is important that the tempered glass be not subjected to spontaneous breakage during formation of the scribe line. The spontaneous breakage is a phenomenon in which the tempered glass sheet is spontaneously broken in the case of receiving damage deeper than the depth of layer due to the influences of the compressive stress in the surface of the tempered glass sheet and the internal tensile stress. When the spontaneous breakage of the tempered glass sheet starts during formation of the scribe line, it becomes difficult to perform desired cutting. Therefore, it is preferred that the depth of the scribe line be controlled within 10 times, 5 times, particularly preferably 3 times of the depth of layer. It should be noted that, in order to form the scribe line, it is preferred to use a diamond wheel tip or the like from the viewpoint of workability.

In the case of performing the post-tempering cutting, it is preferred that a part or a whole of an edge region, in which the end surface (cut surface) and the surface of the tempered glass sheet cross each other, be chamfered, and it is preferred that a part or a whole of the edge region at least on a display side be chamfered. As chamfering processing, R chamfering is preferred, and in this case, R chamfering with a radius of curvature of from 0.05 mm to 0.5 mm is preferred. Further, C chamfering with a radius of curvature of from 0.05 mm to 0.5 mm is also preferred. Further, the surface roughness Ra of a chamfered surface is preferably 1 nm or less, 0.7 nm or less, or 0.5 nm or less, particularly preferably 0.3 nm or less. With this, cracks originated from the edge region can be prevented easily. Herein, the “surface roughness Ra” refers to a value measured by a method in conformity with JIS B0601:2001.

An arrangement of glass sheets to be tempered of the present invention has a feature in that a plurality of glass sheets to be tempered, each having a substantially rectangular shape and a sheet thickness of 1.0 mm or less, are arranged in a support in an upright posture in a thickness direction at an interval of 10 mm or less. Further, an arrangement of tempered glass sheets of the present invention has a feature in that a plurality of tempered glass sheets, each having a substantially rectangular shape and a sheet thickness of 1.0 mm or less, are arranged in a support in an upright posture in a thickness direction at an interval of 10 mm or less. Herein, the technical features of the arrangement of glass sheets to be tempered and the arrangement of tempered glass sheets of the present invention are described in the section in which the method of manufacturing a tempered glass sheet of the present invention is described, and hence the detailed descriptions thereof are omitted here for convenience.

A support of the present invention is a support for arranging a plurality of tempered glass sheets, each having a substantially rectangular shape and a sheet thickness of 1.0 mm or less, in an upright posture in a thickness direction, and has a feature of comprising a support portion for arranging a plurality of tempered glass sheets at an interval of 10 mm or less. Herein, the technical features of the support of the present invention are described in the section in which the method of manufacturing a tempered glass sheet of the present invention is described, and hence the detailed description thereof is omitted for convenience.

### Example 1

Hereinafter, the present invention is described in detail with reference to Examples. It should be noted that the following Examples are merely illustrative. The present invention is by no means limited to the following Examples.

Examples (Sample Nos. 1 to 4) are shown in Table 1.

TABLE 1

| | | | Rapid | Warpage ratio | |
|---|---|---|---|---|---|
| | Furnace | Furnace | cooling | Before | |
| | cooling end | cooling | temperature | ion | After ion |
| Sample | temperature | time | range | exchange | exchange |
| No. 1 | 410° C. | 1 minute | 20° C. to | 0.05% | 0.23% |
| | | | 410° C. | | |
| No. 2 | 310° C. | 15 minutes | 20° C. to | 0.03% | 0.13% |
| | | | 310° C. | | |
| No. 3 | 250° C. | 60 minutes | 20° C. to | 0.03% | 0.05% |
| | | | 250° C. | | |
| No. 4 | 200° C. | 180 minutes | 20° C. to | 0.03% | 0.03% |
| | | | 200° C. | | |

Glass sheets to be tempered were produced as follows. First, glass raw materials were blended to produce a glass batch. Next, the glass batch was loaded into a continuous melting furnace and formed into a sheet shape having a sheet thickness of 0.7 mm by an overflow down-draw method after a fining step, a stirring step, and a supply step. Then, the resultant was cut into dimensions of 120 mm×180 mm to produce a plurality of glass sheets to be tempered. Each of the glass sheets to be tempered comprises as a glass composition, in terms of mass %, 57.4% of SiO₂, 13% of Al₂O₃, 2% of B₂O₃, 2% of MgO, 2% of CaO, 0.1% of Li₂O, 14.5% of Na₂O, 5% of K₂O, and 4% of ZrO₂, and has a density of 2.54 g/cm³, a strain point of 517° C., a thermal expansion coefficient of 99.9×10⁻⁷/° C., a temperature at 10^{4.0} dPa·s of 1,098° C., a temperature at 10^{2.5} dPa·s of 1,392° C., a liquidus temperature of 880° C., and a liquidus viscosity of 10^{5.5} dPa·s. In addition, the glass sheets to be tempered each have an unpolished surface. Further, when the glass sheets to be tempered are immersed in a KNO₃ molten salt at 430° C. for 420 minutes, the compressive stress of the compressive stress layer is 680 MPa, and the depth of layer is 43 μm.

Next, 24 of the resultant glass sheets to be tempered were arranged in a support in an upright posture in a thickness direction at an interval of 6 mm to obtain an arrangement of glass sheets to be tempered. The arrangement of glass sheets to be tempered was preheated and then immersed in a KNO₃ molten salt at 430° C. for 420 minutes to obtain an arrangement of tempered glass sheets.

Then, the arrangement of tempered glass sheets was removed from the KNO₃ molten salt to be immediately transferred into a heat insulating container and was subjected to furnace cooling to a temperature in the table. After reaching the temperature in the table, the arrangement of tempered glass sheets was transferred to room temperature (20° C.) and rapidly cooled. It should be noted that, in the rapid cooling temperature range, the temperature decrease rate from the furnace cooling end temperature to 100° C. was more than 60° C./min. After that, the 24 tempered glass sheets were removed from the arrangement of tempered glass sheets.

Each tempered glass sheet of Sample Nos. 1 to 4 was evaluated for a warpage ratio. Specifically, a profile of a linear measurement region was obtained by putting up the tempered glass sheet in a stage on a state of being inclined at 87° with respect to a horizontal plane and scanning the linear measurement region offset by 5 mm from an upper end surface into a plane of the tempered glass sheet with a laser displacement gauge (manufactured by Keyence Corporation). Then, a maximum displacement amount of the profile with respect to a straight line connecting both ends of the profile was determined as a warpage level, and a value obtained by dividing the warpage level by a measurement distance was defined as a warpage ratio. In the table, an average value of the warpage ratios of the 24 tempered glass sheets is shown. It should be noted that the glass sheets to be tempered were also evaluated for a warpage ratio similarly.

As is apparent from Table 1, in Sample Nos. 1 to 4, an increase range of the warpage level is suppressed by furnace cooling (annealing). Further, it is understood from Table 1 that, as the annealing time is longer, the warpage level is more likely to be suppressed. Further, when the annealing end temperature is high, although the warpage level can improve, the compressive stress of the compressive stress layer lowers, and the depth of layer is liable to increase. Therefore, it is expected that the ion exchange reaction is liable to proceed due to the heat treatment.

### Example 2

An arrangement of tempered glass sheets was produced in the same way as in [Example 1]. After that, the arrangement of tempered glass sheets was immediately transferred from a KNO₃ molten salt into an annealing furnace retained at 310° C. and was retained therein for 60 minutes. Then, the arrangement of tempered glass sheets was transferred to room temperature (20° C.) and rapidly cooled. After that, 24 tempered glass sheets were removed from the arrangement of tempered glass sheets, and each tempered glass sheet was evaluated for a warpage ratio in the same way as in [Example 1]. As a result, an average value was 0.13%. It should be noted that an average value of the warpage ratios of the glass sheets to be tempered was 0.03%.

### Example 3

An arrangement of tempered glass sheets was produced in the same way as in [Example 1]. After that, the arrangement of tempered glass sheets was immediately transferred from a KNO₃ molten salt into an annealing furnace retained at 310° C. and was retained therein for 60 minutes. Then, the arrangement of tempered glass sheets was subjected to furnace cooling in the annealing furnace with a power source turned off. After that, 24 tempered glass sheets were removed from the arrangement of tempered glass sheets, and each tempered glass sheet was evaluated for a warpage ratio in the same way as in [Example 1]. As a result, an average value was 0.01%. It should be noted that an average value of the warpage ratios of the glass sheets to be tempered was 0.03%.

### Example 4

An arrangement of tempered glass sheets was produced in the same way as in [Example 1]. After that, the arrangement of tempered glass sheets was immediately transferred from a KNO₃ molten salt into an annealing furnace retained at 410° C. and was retained therein for 10 minutes. Then, a power source of the annealing furnace was turned off, and the arrangement of tempered glass sheets was forcibly cooled to room temperature (20° C.) by air-sending means. After that, 24 tempered glass sheets were removed from the arrangement of tempered glass sheets, and each tempered glass sheet was evaluated for a warpage ratio in the same way as in [Example 1]. As a result, an average value was 0.07%. It should be noted that an average value of the warpage ratios of the glass sheets to be tempered was 0.03%.

It should be noted that it is considered that the tendencies exhibited in [Example 1] to [Example 4] are also obtained in the glass sheets to be tempered (Samples “a” to “e”) shown in Table 2 in the same manner.

TABLE 2

| | | a | b | c | d | e |
|---|---|---|---|---|---|---|
| Glass | SiO₂ | 66.0 | 58.8 | 61.7 | 61.19 | 62.4 |
| composition | Al₂O₃ | 14.2 | 21.4 | 19.7 | 16.2 | 12.9 |
| (mass %) | B₂O₃ | 2.3 | 4.9 | 3.6 | 0.8 | 2.0 |
| | Li₂O | 0.1 | — | — | — | 0.1 |
| | Na₂O | 13.4 | 13.1 | 13.2 | 14.1 | 16.0 |
| | K₂O | 0.6 | — | — | 3.4 | 2.0 |
| | MgO | 3.0 | 1.5 | 1.5 | 3.6 | — |
| | CaO | — | — | — | 0.5 | 2.0 |
| | ZrO₂ | — | 0.1 | 0.1 | 0.01 | 2.5 |
| | SnO₂ | 0.4 | 0.2 | 0.2 | 0.2 | 0.1 |

### Example 5

Glass sheets to be tempered were produced as follows. First, glass raw materials were blended to produce a glass batch so as to comprise as a glass composition, in terms of mass %, 61.4% of SiO₂, 18% of Al₂O₃, 0.5% of B₂O₃, 0.1% of Li₂O, 14.5% of Na₂O, 2% of K₂O, 3% of MgO, 0.1% of BaO, and 0.4% of SnO₂. Next, the glass batch was loaded into a continuous melting furnace and formed into a sheet shape by an overflow down-draw method after a fining step, a stirring step, and a supply step. Then, the resultant was cut into dimensions of 1,800 mm×1,500 mm×0.5 mm (thickness) to produce glass sheets to be tempered (parent sheets). It should be noted that the glass sheets to be tempered each have a density of 2.45 g/cm³, a strain point of 563° C., a thermal expansion coefficient of 91.3×10⁻⁷/° C., a temperature at 10^{4.0} dPa·s of 1,255° C., a temperature at 10^{2.5} dPa·s of 1,590° C., a liquidus temperature of 970° C., and a liquidus viscosity of 10^{6.3} dPa·s. In addition, the glass sheets to be tempered each have an unpolished surface. Further, when the glass sheets to be tempered are immersed in a KNO₃ molten salt at 430° C. for 240 minutes, the compressive stress of the compressive stress layer is 900 MPa, and the depth of layer is 43 μm. It should be noted that, in the calculation, the refractive index and optical elastic constant of each of samples were defined as 1.50 and 29.5 [(nm/cm)/MPa], respectively.

Next, 24 of the resultant glass sheets to be tempered were arranged in a support in an upright posture in a thickness direction at an interval of 5 mm to obtain an arrangement of glass sheets to be tempered. The arrangement of glass sheets to be tempered was preheated and then immersed in a KNO₃ molten salt at 430° C. for 240 minutes to obtain an arrangement of tempered glass sheets.

Then, the arrangement of tempered glass sheets was removed from the KNO₃ molten salt to be immediately transferred into a heat insulating container and was subjected to furnace cooling to 310° C. over 15 minutes. After reaching 310° C., the arrangement of tempered glass sheets was transferred to room temperature (20° C.) and rapidly cooled. It should be noted that, in the rapid cooling temperature range, the temperature decrease rate from the furnace cooling end temperature to 100° C. was more than 60° C./min. After that, the 24 tempered glass sheets were removed from the arrangement of tempered glass sheets.

Each tempered glass sheet thus obtained was evaluated for a warpage ratio. Specifically, a profile of a linear measurement region was obtained by putting up the tempered glass sheet on a stage in a state of being inclined at 87° with respect to a horizontal plane and scanning the linear measurement region offset by 5 mm from an upper end surface into a plane of the tempered glass sheet with a laser displacement gauge (manufactured by Keyence Corporation). Then, a maximum displacement amount of the profile with respect to a straight line connecting both ends of the profile was determined as a warpage level, and a value obtained by dividing the warpage level by a measurement distance was defined as a warpage ratio. As a result, an average value of warpage ratios of the 24 tempered glass sheets was 0.14%. It should be noted that, when the glass sheets to be tempered were also evaluated for a warpage ratio similarly, an average value was 0.05%.

Further, a scribe line was formed on a surface of the obtained tempered glass sheet, and the tempered glass sheet was bent and split along the scribe line so that the tempered glass sheet was divided into a 7-inch size. It should be noted that, in the formation of the scribe line, scribing was performed so as to start from an end surface and end in a region on an inner side by 5 mm or more from an opposing end surface. Further, in the scribe cutting, the depth of the scribe line was set to be larger than the depth of layer.

### Example 6

First, glass raw materials were blended to produce a glass batch so as to comprise as a glass composition, in terms of mass %, 61.4% of SiO₂, 18% of Al₂O₃, 0.5% of B₂O₃, 0.1% of Li₂O, 14.5% of Na₂O, 2% of K₂O, 3% of MgO, 0.1% of BaO, and 0.4% of SnO₂. Next, the glass batch was loaded into a continuous melting furnace and formed into a sheet shape by an overflow down-draw method after a fining step, a stirring step, and a supply step. Then, the resultant was cut into dimensions of 1,800 mm×1,500 mm×0.5 mm (thickness) to produce glass sheets to be tempered (parent sheets). It should be noted that the glass sheets to be tempered each have a density of 2.45 g/cm³, a strain point of 563° C., a thermal expansion coefficient of 91.3×10⁻⁷/° C., a temperature at 10^{4.0} dPa·s of 1,255° C., a temperature at 10^{2.5} dPa·s of 1,590° C., a liquidus temperature of 970° C., and a liquidus viscosity of 10^{6.3} dPa·s.

Next, 24 of the resultant glass sheets to be tempered (parent sheets) were arranged in a support in an upright posture in a thickness direction at an interval of 5 mm to obtain an arrangement of glass sheets to be tempered. The arrangement of glass sheets to be tempered was preheated and then immersed in a KNO₃ molten salt at 430° C. for 240 minutes to obtain an arrangement of tempered glass sheets. Then, the compressive stress and the depth of layer of the compressive stress layer of the tempered glass sheet were calculated by the same method as above, and as a result, the compressive stress and the depth of layer were 900 MPa and 43 μm, respectively. It should be noted that, in the calculation, the refractive index and optical elastic constant of each of samples were defined as 1.50 and 29.5 [ (nm/cm)/MPa], respectively.

Further, a scribe line was formed on a surface of the obtained tempered glass sheet, and the tempered glass sheet was bent and split along the scribe line so that the tempered glass sheet was divided into pieces each having a predetermined size (7-inch size). It should be noted that, in the formation of the scribe line, scribing was performed so as to start from an end surface and end in a region on an inner side by 5 mm or more from an opposing end surface. Further, in the scribe cutting, the depth of the scribe line was set to be larger than the depth of layer.

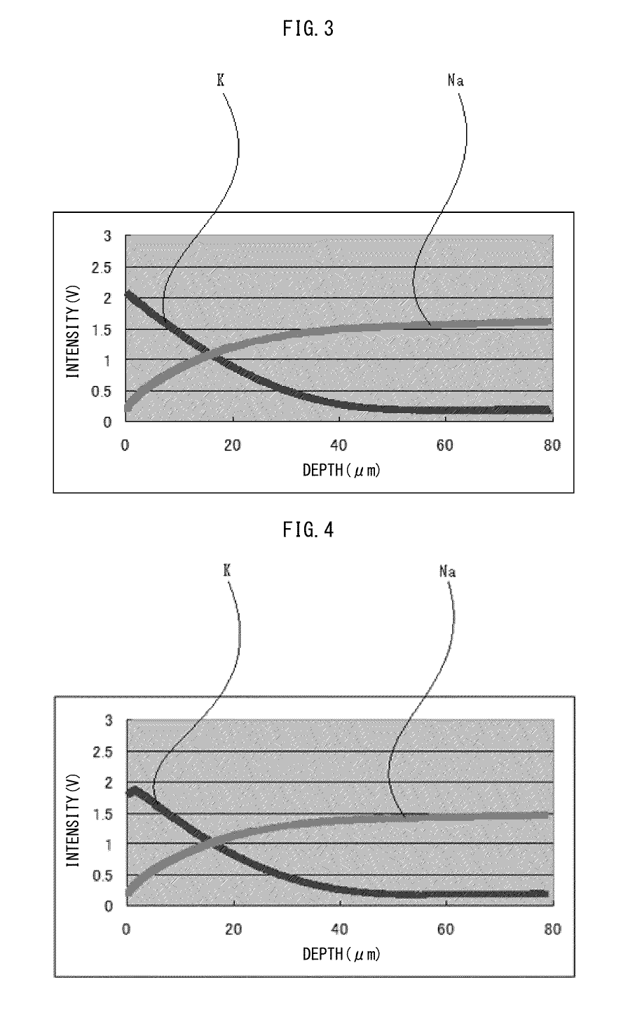

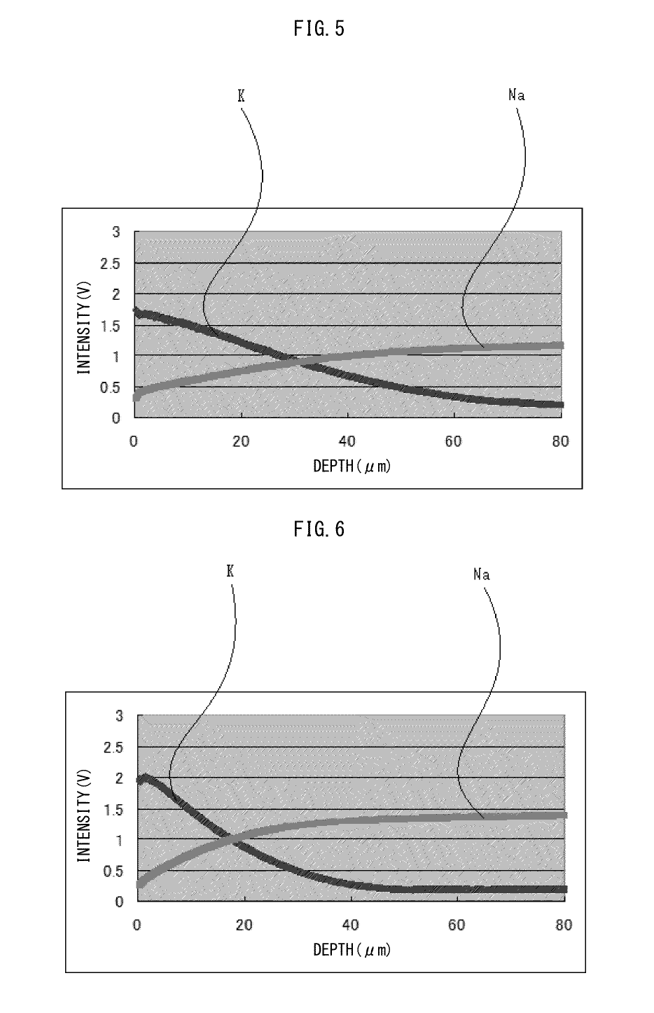

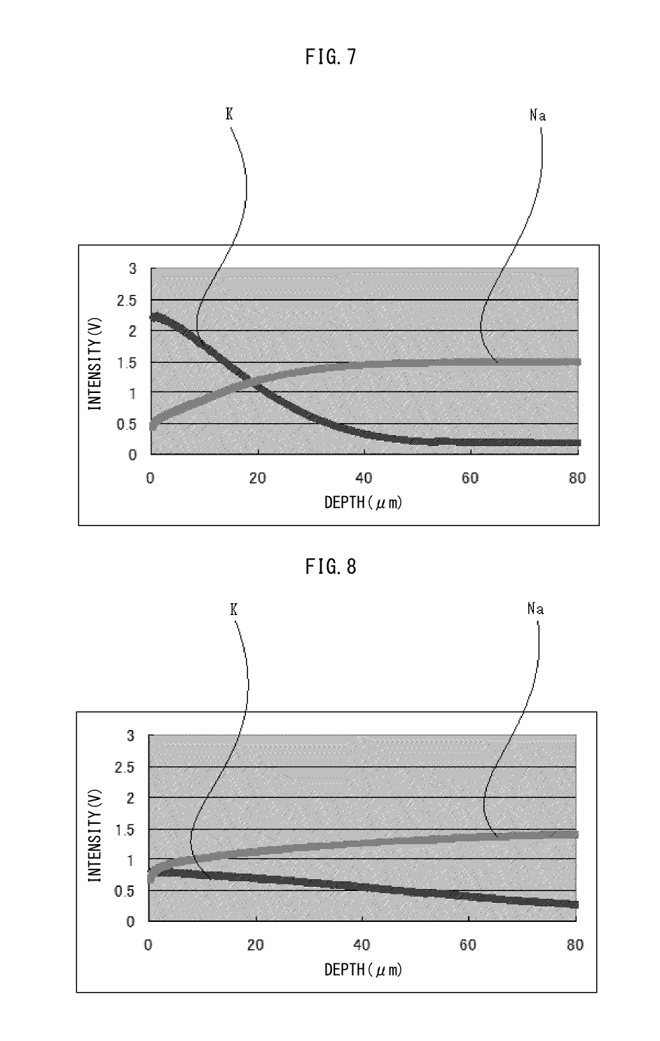

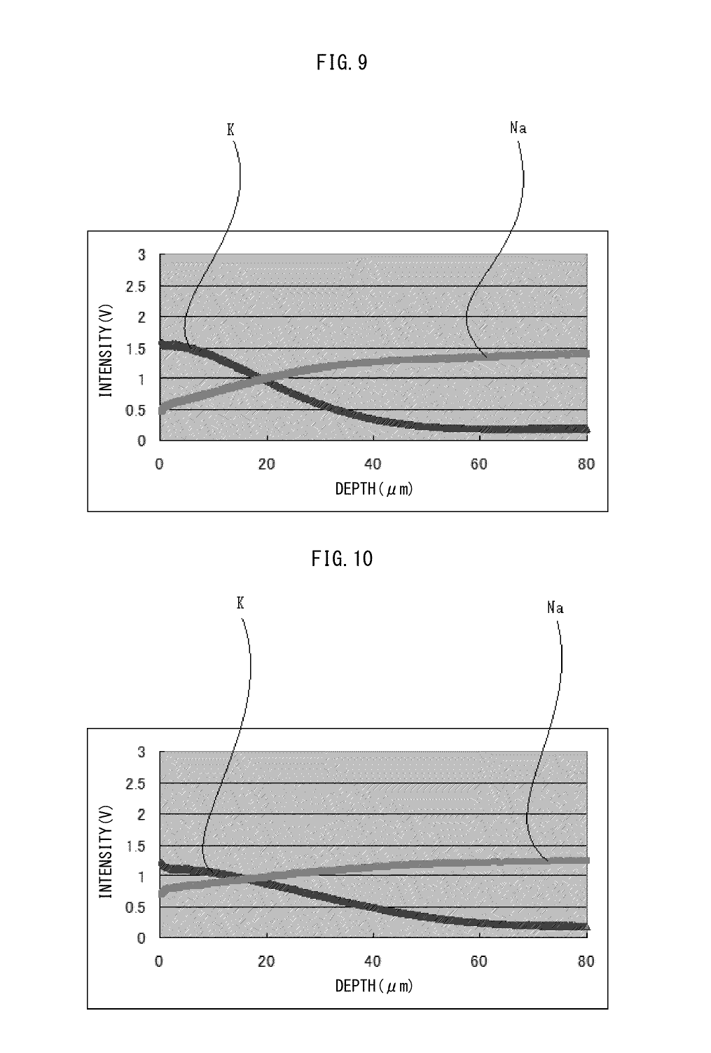

Further, the obtained tempered glass sheet (each piece) was subjected to heat treatment (temperature increase rate: 5° C./min, temperature decrease rate: furnace cooling) shown in Table 3 to produce Sample Nos. 6 to 12. The heat-treated samples thus obtained were each measured for a ratio of (internal K emission intensity)/(surface layer K emission intensity) by GD-OES (GD-Profiler 2 manufactured by Horiba, Ltd.). The results are shown in Table 3 and FIG. 3 to FIG. 10. It should be noted that Sample No. 5 in Table 3 is a tempered glass sheet before being subjected to the heat treatment. Further, the measurement conditions were set to a discharge electric power of 80 W and a discharge pressure of 200 Pa.

TABLE 3

| | Heat treatment | Heat treatment | K emission |
|---|---|---|---|
| Sample | temperature | time | intensity ratio |
| No. 5 | No heat treatment | | 0.67 |
| No. 6 | 300° C. | 1 hour | 0.71 |
| No. 7 | | 24 hours | 0.86 |
| No. 8 | 400° C. | 15 minutes | 0.73 |
| No. 9 | | 1 hour | 0.77 |
| No. 10 | | 24 hours | 0.92 |
| No. 11 | 500° C. | 15 minutes | 0.85 |
| No. 12 | | 1 hour | 0.86 |

In a strict sense, the experiment according to Table 3 is not conducted by an annealing step but separate heat treatment. However, the data according to Table 3 can be used for estimating a ratio of (internal K emission intensity)/(surface layer K emission intensity) regarding the tempered glass sheet after the annealing step.

### INDUSTRIAL APPLICABILITY

The tempered glass sheet according to the present invention is suitable for a cover glass of a display device, such as a cellular phone, a digital camera, or a PDA. Further, the tempered glass sheet according to the present invention can be expected to find use in applications requiring a high mechanical strength, for example, a window glass, a substrate for a magnetic disk, a substrate for a flat panel display, a cover glass for a solid image pick-up element, and tableware, in addition to the above-mentioned applications.

The method of manufacturing a tempered glass sheet of the present invention can also be applied to tempered glass sheets of 2D, 2.5D, and 3D in which a surface is curved in an plane direction, as well as a tempered glass sheet having a flat sheet shape. In the case where the method of manufacturing a tempered glass sheet of the present invention is applied to the tempered glass sheets of 2D, 2.5D, and 3D, deformation other than a desired curved shape corresponds to a warpage level.

### REFERENCE SIGNS LIST

1 support
2 frame portion
2a bottom frame portion
2b both-side frame portion
2c front frame portion
2d back frame portion
2e beam frame portion
3 glass sheet to be tempered
4 support portion
4a side edge support portion
4b lower end support portion
5 heat retention plate
10 air-sending device
11 enclosure
12 arrangement of tempered glass sheets
13 air-sending means

1. A method of manufacturing a tempered glass sheet, comprising:
an arrangement step of arranging a plurality of glass sheets to be tempered, each having a substantially rectangular shape and a sheet thickness of 1.0 mm or less, in a support in an upright posture in a thickness direction at an interval of 10 mm or less, to thereby obtain an arrangement of glass sheets to be tempered;
a tempering step of immersing the arrangement of glass sheets to be tempered in an ion exchange solution so as to subject the arrangement of glass sheets to be tempered to ion exchange treatment, to thereby obtain an arrangement of tempered glass sheets;
an annealing step of annealing the arrangement of tempered glass sheets after removing the arrangement of tempered glass sheets from the ion exchange solution; and
a removal step of removing each of tempered glass sheets forming the arrangement of tempered glass sheets from the support.

2. The method of manufacturing a tempered glass sheet according to claim 1, wherein the annealing is performed so that an average warpage ratio of all the tempered glass sheets forming the arrangement of tempered glass sheets is less than 0.5%.

3. The method of manufacturing a tempered glass sheet according to claim 1, wherein a cooling time from a temperature of the ion exchange solution to a temperature of 100° C. is 1 minute or more in the annealing step.

4. The method of manufacturing a tempered glass sheet according to claim 1, wherein the arrangement of tempered glass sheets is retained at a temperature of 100° C. or more and less than (strain point-100°) C. during the annealing.

5. The method of manufacturing a tempered glass sheet according to claim 1, wherein the annealing is performed under a state in which the arrangement of tempered glass sheets is placed in a heat insulating structure.

6. The method of manufacturing a tempered glass sheet according to claim 1, wherein the annealing is performed so that the tempered glass sheets each have a ratio of (internal K emission intensity)/(surface layer K emission intensity) of more than 0.67 and 0.95 or less.

7. The method of manufacturing a tempered glass sheet according to claim 1, wherein air is sent to the arrangement of tempered glass sheets during the annealing.

8. The method of manufacturing a tempered glass sheet according to claim 1, further comprising a post-tempering cutting step of cutting each of the tempered glass sheets into a predetermined size after the removal step.

9. The method of manufacturing a tempered glass sheet according to claim 1, wherein the plurality of glass sheets to be tempered each comprise a glass sheet to be tempered formed by an overflow down-draw method.

10. The method of manufacturing a tempered glass sheet according to claim 1, wherein the ion exchange treatment is performed so that a compressive stress of a compressive stress layer of each of the tempered glass sheets is 400 MPa or more, and a depth of layer of the compressive stress layer is 15 μm or more.

11. The method of manufacturing a tempered glass sheet according to claim 1, wherein the plurality of glass sheets to be tempered each comprise a glass sheet to be tempered comprising 1 mass % to 20 mass % of Na₂O in a glass composition.

12. The method of manufacturing a tempered glass sheet according to claim 1, wherein the plurality of glass sheets to be tempered each comprise a glass sheet to be tempered comprising as a glass composition, in terms of mass %, 50% to 80% of SiO₂, 5% to 25% of Al₂O₃, 0% to 15% of B₂O₃, 1% to 20% of Na₂O, and 0% to 10% of K₂O.

13. The method of manufacturing a tempered glass sheet according to claim 1, wherein the plurality of glass sheets to be tempered each comprise a glass sheet to be tempered having a strain point of 500° C. or more.

14. The method of manufacturing a tempered glass sheet according to claim 1, wherein the method is free of a polishing step of polishing a whole or a part of a surface of each of the tempered glass sheets.

15. The method of manufacturing a tempered glass sheet according to claim 1, wherein the method is used for a cover glass of a display device.

16. An arrangement of glass sheets to be tempered, comprising a plurality of glass sheets to be tempered, each having a substantially rectangular shape and a sheet thickness of 1.0 mm or less, arranged in a support in an upright posture in a thickness direction at an interval of 10 mm or less.

17. An arrangement of tempered glass sheets, comprising a plurality of tempered glass sheets, each having a substantially rectangular shape and a sheet thickness of 1.0 mm or less, arranged in a support in an upright posture in a thickness direction at an interval of 10 mm or less.

18. The arrangement of tempered glass sheets according to claim 17, wherein an average warpage ratio of all the tempered glass sheets is less than 0.5%.

19. A tempered glass sheet having a substantially rectangular shape, the tempered glass sheet having a sheet thickness of 0.7 mm or less and a warpage ratio of less than 0.5%.

20. The tempered glass sheet according to claim 19, wherein the tempered glass sheet has a ratio of (internal K emission intensity)/(surface layer K emission intensity) of more than 0.67 and 0.95 or less.

21. A support for arranging a plurality of tempered glass sheets, each having a substantially rectangular shape and a sheet thickness of 1.0 mm or less, in an upright posture in a thickness direction, the support comprising a support portion for arranging the plurality of tempered glass sheets at an interval of 10 mm or less.
